(19) United States
(12) Patent Application Publication
(10) Pub. No.: US 2025/0231155 A1
(43) Pub. Date: Jul. 17, 2025

(54) ANALYZING GASES FROM INCLUSIONS IN MINERALS

(71) Applicant: Saudi Arabian Oil Company, Dhahran (SA)

(72) Inventors: Feng Hu Lu, Dhahran (SA); Salman Mohammed Qathami, Dhahran (SA); Sattam S. Mutairi, Dhahran (SA); Mohammad Rowaie, Dhahran (SA)

(21) Appl. No.: 18/414,015

(22) Filed: Jan. 16, 2024

(51) Int. Cl. G01N 30/72; G01N 1/22; G01N 30/02; G01N 30/06; G01N 30/12

(52) U.S. Cl. CPC G01N 30/7206; G01N 1/22; G01N 2001/227; G01N 2030/025; G01N 2030/062; G01N 2030/122

(57) ABSTRACT

Systems and methods for extracting and analyzing gases trapped in inclusions in solid rock, mineral, or subterranean samples. Systems include a rotating ball mill in fluid communication with analytical instrumentation.

### TECHNICAL FIELD

This document relates to systems and methods for extracting and analyzing gas inclusions in minerals, cements, rocks, and subterranean samples.

### BACKGROUND

Natural gas can be trapped as gas inclusions in certain minerals, diagenetic cements, rocks, and subterranean samples. The gas can include light hydrocarbon gas compounds, for example, methane, ethane, and propane, as well as non-hydrocarbon components, for example CO₂, N₂, and H₂. Analyses of chemical and isotope compositions from these gases can provide important information on gas formation, gas sources, and gas absorption/desorption kinetics.

### SUMMARY

This disclosure describes systems and methods for extracting and analyzing gases trapped in inclusions in minerals, cements, rocks, and subterranean samples.

The following units of measure have been mentioned in this disclosure:

In some implementations, a system for analyzing gases trapped in inclusions in a solid sample includes an inert gas source, and a ball mill in fluid connection with the inert gas source. The ball mill includes a hollow cylinder and a plurality of crushing balls disposed inside the cylinder, and the ball mill is configured to be rotated around the longitudinal axis of the cylinder. The system includes a first valve disposed between the inert gas source and the ball mill, a cryogenic trap configured to cool the gases released from the inclusions, a second valve disposed between the ball mill and the cryogenic trap and in fluid connection with the ball mill, a third valve disposed between the cryogenic trap and an analysis instrument and in fluid connection with the second valve, and a fourth valve disposed between the third valve and the analysis instrument, wherein the fourth valve is a three way valve, wherein the three way valve can be opened to the atmosphere.

In some implementations, a method for analyzing gases trapped in inclusions in a solid sample includes placing a solid sample in a ball mill, wherein the ball mill includes a hollow cylinder and a plurality of crushing balls disposed inside the cylinder, purging the ball mill of air, sealing the ball mill, rotating the ball mill to crush the solid sample and release the gases from the inclusions, directing the gases through a cryogenic trap, condensing the gases in the cryogenic trap forming condensed gases, removing the cryogenic trap to release the condensed gases forming released gases, directing the released gases through a gas chromatography column, separating the released gases based on the interaction between the released gases and a stationary phase of the column, and analyzing the released gases using a mass spectrometer.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1A shows an example schematic of a gas inclusion analysis system.

FIG. 1B shows an example cross section of a ball mill.

FIG. 2 shows a schematic of an example ball mill.

FIG. 3 is an example schematic of a cross section of steel caps.

FIG. 4 shows a schematic of an example three-way valve in fluid connection with an example ball mill.

FIG. 5 shows a schematic of an example hydrogen sulfide trap.

FIG. 6 is a flow chart of an example method of analyzing gases from inclusions.

FIG. 7 is a flow chart of an example method of analyzing gases from inclusions.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure, in part, are systems and methods for extracting and analyzing gas inclusions in minerals, cements, rocks, and subterranean samples. Gas can be trapped as gas inclusions in certain minerals, rocks, and subterranean samples. The trapped gas can include light hydrocarbons, for example methane, ethane, and propane. The trapped gas can also include non-hydrocarbon components, for example CO₂, N₂, and H₂. Analyses of the chemical and isotope compositions of these gases can provide important information, including gas formation, gas sources, geochemical reactions, and gas absorption/desorption kinetics. In order to analyze the gas inclusions, the gases need to be extracted from the minerals, rocks, or other samples, and transferred to instruments without air contamination. Provided in this disclosure, in part, are methods, apparatuses, and systems for extracting gas inclusions, concentrating or partitioning gases with a cryogenic trap, and analyzing the composition of the extracted gases.

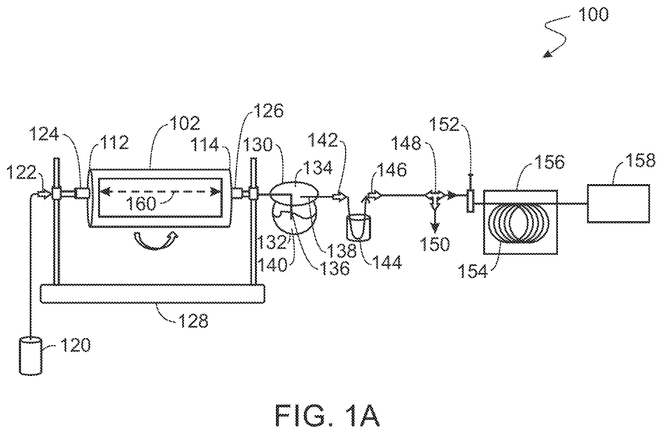

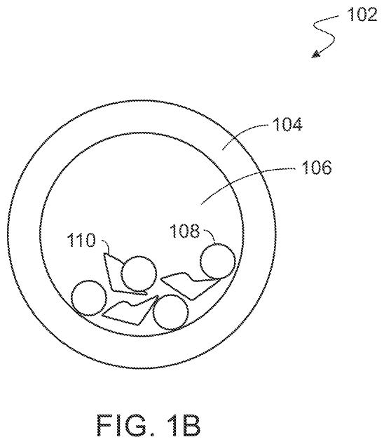

FIG. 1A shows an example schematic of a gas inclusion analysis system 100. The analysis system 100 includes a ball mill 102. The ball mill 102 is a hollow stainless-steel cylinder. FIG. 1B shows an example cross section of the ball mill 102. The ball mill 102 includes a stainless-steel wall 104. The ball mill 102 includes crushing aids, for example, stainless steel balls 108. The stainless-steel balls 108 can be placed in the hollow center 106 of the ball mill 102. The rock or mineral samples 110 to be analyzed can also be placed in the hollow center of the ball mill 102.

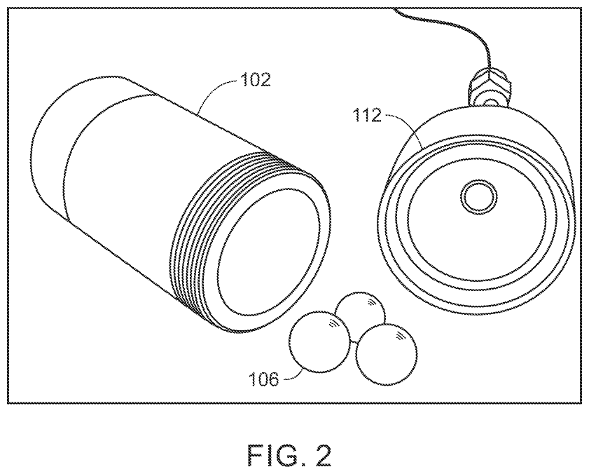

The size of the stainless-steel cylinder and the steel balls inside the cylinder may vary, depending on the nature of minerals and rocks. For gas inclusions in small minerals or cements, the size of the cylinder may be 3 cm (D: diameter)×7 cm (L: length), and the diameter of the balls may be 1 cm. An example schematic of this implementation is shown in FIG. 2. For larger samples, for example rock slabs, the size of the cylinder can be 6 cm (D)×10 cm (L) or more, and the size of the balls can be 2 cm (D) or larger. In addition, the number of the balls can be 3 to 6, depending on the size and amount of the samples.

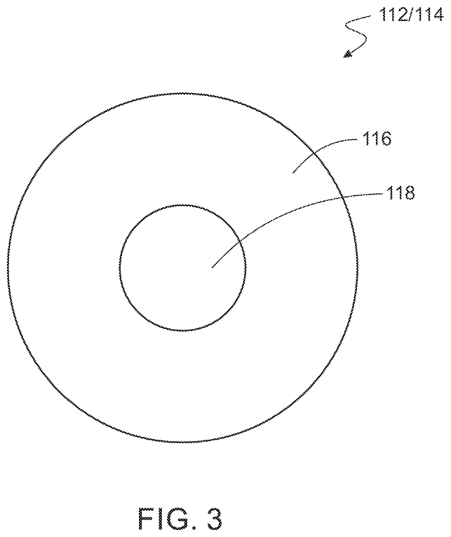

The cylinder is capped at either end with steel caps 112 and 114. The steel caps 112 and 114 can be screwed on to the cylinder to form an airtight seal. The steel caps include an inner aperture that can be opened and closed with valves. FIG. 3 is an example schematic of a cross section of the steel caps 112/114 with a cap body 116 and an inner aperture 118.

In some implementations, the cylinder can be rotated or shook manually. In some implementations, the ball mill 102 is mounted on a stand 128, and configured so that the ball mill can be rotated around its longitudinal axis 160. The steel caps 112 and 114 can be attached to a first bearing A08 and a second bearing 126, respectively. The bearings 124 and 126 are configured such that the cylinder can be mounted on the stand 128 and also spin around the longitudinal axis 160. In some implementations, the ball mill 102 can by spun by an electric motor.

Rotating the cylinder ensures that there are no pockets of untouched sample, and makes the sample crushing more efficient and uniform. Accordingly, a rotating crushing system and method ensures all gases are released from a given rock, mineral, or subterranean sample.

The system 100 includes an inert gas source 120. The inert gas source is fluidly coupled to the ball mill 102 via a first valve 122 at a first end of the ball mill 102 via stainless steel tubes. In some implementations, the inert gas is helium gas (He).

At the second end of the ball mill, the ball mill is fluidly coupled to second valve 142 and a third valve 146. Between valves 142 and 146 the system is configured such the released gases pass through a cryogenic trap 144. The cryogenic trap is configured to hold a cryogenic liquid. In some implementations, the cryogenic liquid is liquid nitrogen. The cryogenic trap 144 can include a lid to prevent evaporation of a cryogenic liquid, for example, liquid nitrogen.

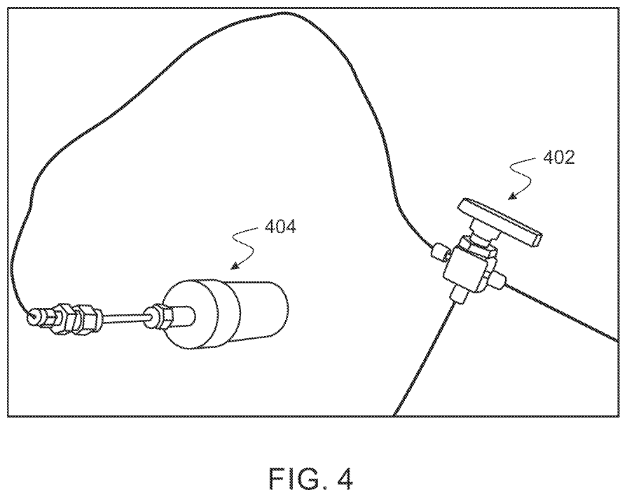

The third valve 146 is fluidly connected to the fourth valve 148. Valve 148 is a 3-way valve. FIG. 4 is a schematic of an example three-way valve 402 in fluid connection with an example ball mill 404. Valve 148 is configured such that one of the three valve openings is connected to a capillary 150 that is open to the surrounding atmosphere. Prior to starting to extract gas from a sample, the system must be purged of air. Accordingly, the three way valve can be switch to an open position with capillary 150 open to the air. After purging, the three-way valve is turned so that capillary 150 is sealed and the valve 148 is open in line with the ball mill and analytical instrument. The valve 148 is in fluid communication with a column 154 that passes through an oven 156. The oven can be used to heat up the samples to facilitate the separation of the sample components. The column, for example a gas chromatography column, is used to separate different gas compounds through interaction between gas sample and the stationary phase of the column. The separated sample gases then proceed to an analysis instrument 158, for example a mass spectrometer.

In some implementations, the system 100 can include a sample injector 152. The fourth valve 148 can be in fluid communication with the sample injector 152 and/or the column 154. The sample injector can be used to inject additional analytes, controls, or other components into the column 154.

In some implementations, the system includes a hydrogen sulfide trap 130 located in line between the ball mill and valve 142. The trap removes hydrogen sulfide gas from the gases released from the samples. Hydrogen sulfide can have a detrimental effect on analytical instruments. Accordingly, it is advantageous to remove hydrogen sulfide before subsequent analysis. Further, the hydrogen sulfide trap can allow for the analyzation of sulfur isotopes, which can yield information about the origin of the hydrogen sulfide. The hydrogen sulfide trap includes a container 132 configured to hold a trapping liquid 140, for example a silver nitrate solution, a Pb(NO₃)₂ solution, Zn-containing compounds, Sulfothane, or SulfurexBR. The container can be a glass or plastic bottle. The hydrogen sulfide trap 130 includes a cap 134 that can be screwed on to the container 132 to form an air-tight seal. The cap 134 includes a gas inlet 136 and a gas outlet 138. The gas inlet is configured such that it extends into container and into the trapping liquid 140. The gases released from the gas inclusions bubble through the silver nitrate solution. The concentration of the silver nitrate can be adjusted depending on the concentration of H₂S in the gas. The reaction between silver nitrate and hydrogen sulfide is shown in the following equation:

$$2 {AgNO}_{3 ( aq )} + {H}_{2} {S}_{( g )} \to {Ag}_{2} {S}_{( s )} + 2 {HNO}_{3 ( aq )} \qquad Eq . 1$$

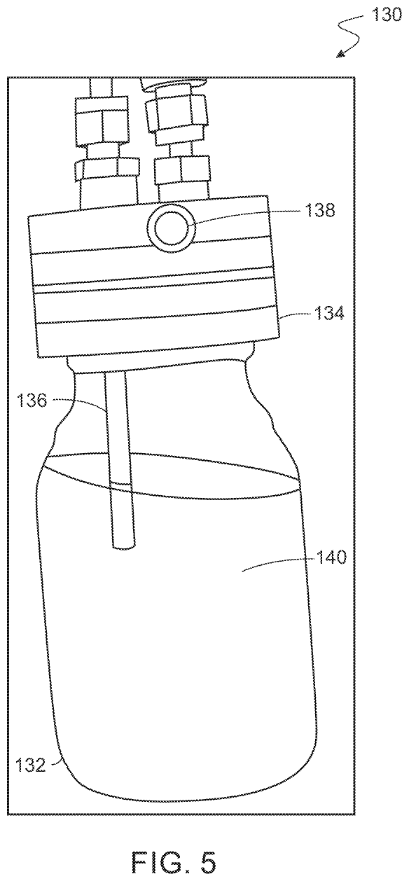

Accordingly, a precipitate of Ag₂S forms in the container. The container can be removed, emptied, and refilled when valve 142 is closed or between analyses. FIG. 5 is a an example schematic of a hydrogen sulfide trap 130.

The analysis system can be used as follows. The selected minerals, rocks, or samples to be analyzed and a number of stainless-steel balls are placed into a ball mill cylinder. Helium is used to purge the air out of the entire system. The ball mill is then sealed and is shaken or rotated (manually or by a motor) in order to crush the samples and release gas inclusions. The ball mill cylinder is then opened to direct the gases through the cryogenic trap. The cryogenic trap can be operated at a number of different freezing temperatures, depending on the identity of the gas inclusions. The cryogenic trap concentrates the gases from the gas inclusions. The concentrated gases are then released into instrumentation for chemical and isotopic analysis.

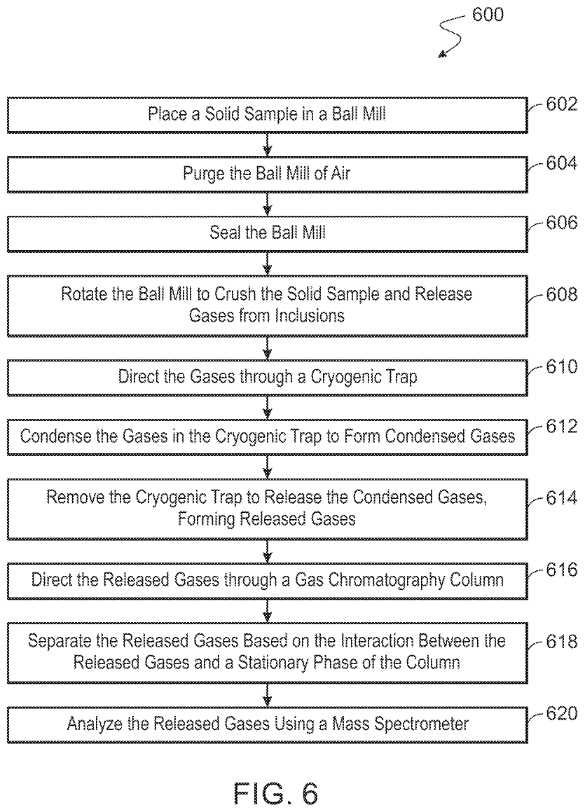

FIG. 6 is a flow chart of an example method 600 of analyzing gases trapped in inclusions in a solid sample. At 602, a solid sample is placed in a ball mill. The ball mill includes a hollow cylinder and a plurality of crushing balls disposed inside the cylinder. At 604, the ball mill is purged of air. At 606, the ball mill is sealed. At 608, the ball mill is rotating to crush the solid sample and release the gases from the inclusions. At 610, the gases are directed through a cryogenic trap. At 612, the gases are condensed in the cryogenic trap forming condensed gases. At 614, the cryogenic trap is removed to release the condensed gases, forming released gases. At 616, the released gases are directed through a gas chromatography column. At 618, the released gases are separated based on the interaction between the released gases and a stationary phase of the column. At 620, the released gases are analyzed using a mass spectrometer.

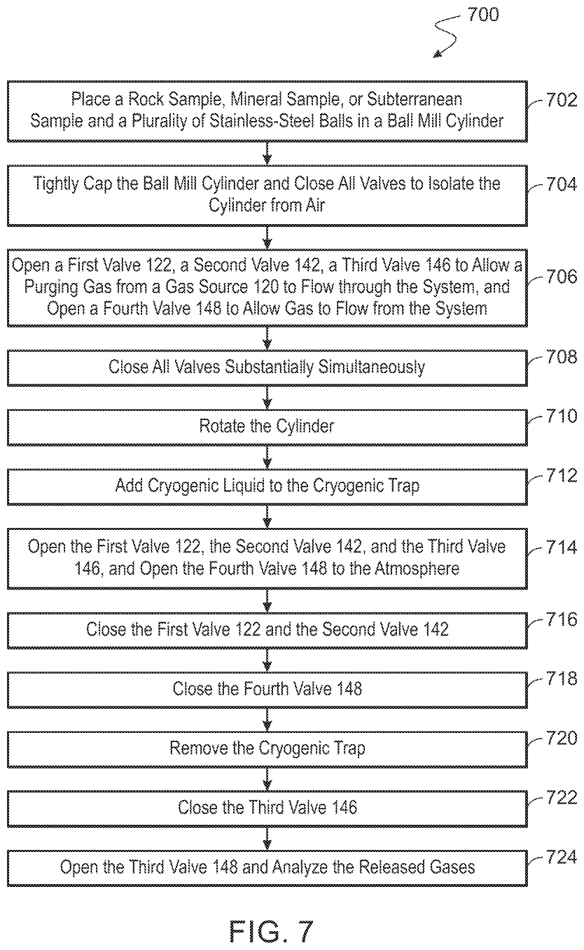

FIG. 7 is a flow chart of an example method 700 of analyzing gases from inclusions. At block 702, a rock sample, mineral sample, or subterranean sample and a plurality of stainless-steel balls are placed inside a ball mill cylinder. The samples should be at least 2× smaller than the diameter of a ball mill cylinder.

At block 704, the ball mill cylinder is tightly capped, and all valves are closed to isolate the samples in the cylinder from air.

At block 706, the first valve 122 is opened, followed by opening the second valve 142 and the third valve 146 to allow a purging gas from a gas source 120 to flow through the system. Substantially simultaneously to opening the second valve 142 and the third valve 146, the fourth valve 148 is opened to the atmosphere to allow gas to flow from the system via capillary 150. This allows helium into the ball mill cylinder and purges are from the system. The system should be purged with helium for at least 10 minutes. The ball mill cylinder should be slowly rotated during this time, to ensure that there is no untouched dead volume of air in the cylinder.

At 708, all valves (122, 142, 146, and 148) are closed substantially simultaneously.

At 710, the cylinder is rotated at a relatively slow speed. For example, for soft sample materials (e.g., carbonate, mudstone) the cylinder can be rotated at less than 5 cycles per second, for example, 2 cycles a second. The cylinder can be rotated with an electric motor or manually. For harder materials (e.g., quartz), the cylinder is rotated at 3× the speed, i.e., 6-15 cycles per second. The cylinder can be removable from the stand 128 for manual rotation.

At 712, cryogenic liquid is added to the cryogenic trap 144. In some implementations, the cryogenic liquid is liquid nitrogen. In some implementations, the cryogenic liquid is a mixture of liquid nitrogen and methanol configured to have a temperature between −201° C. and −100° C. to release natural gas compounds (e.g., C1, C2, and C3 hydrocarbons) but retain heavier gas (e.g., CO₂) for subsequent analysis.

At 714, valves 122, 142, and 146 are opened and valve 148 is opened to the atmosphere to purge all gas released from the cylinder and to direct the gas into the cryogenic trap. The valves are opened for approximately 10 minutes. The cryogenic trap can be configured in order to trap gases of interest in the trap, while unwanted gases escape to the atmosphere through valve 148 and capillary 150. For example, the liquid in the cryogenic trap can be configured to have a temperature that traps gases of interest in the trap.

At 716, valves 122 and 142 are closed.

At 718, valve 142 remains closed, valve 148 is closed and valve 146 remains opened.

At 720, the cryogenic trap is removed. In some implementations, the stainless steel tubing connecting the valves is frozen. The frozen section of the tubing can be heated using a heating gun after removing the trap. The gas previously trapped in the cryogenic trap will now be released towards valve 146 and 148. Valve 146 remains open for 10 minutes or until the frozen section of the system is warmed to room temperature.

At 722, valve 146 is closed, trapping the gases between valves 146 and 148.

At 724, valve 148 is opened to the analysis instrument and the released gases are analyzed. Valve 148 can be manipulated to release only a portion of gas from a section of the system between valve 146 and 148, so that multiple analyses can be conducted. Multiple analyses can be conducted for different gas compounds, for example, analyses of hydrocarbon and non-hydrocarbon gases. In addition, valve 146 can be closed and valve 148 can be kept open to release gas from between valves 146 and 148 first. Subsequently, valve 146 can be opened to release gas from between valves 142 and 146 for subsequent analyses.

### Example 1: Analysis of Dolomite Mineral

A sample of dolomite mineral as a vein in a sandstone gas reservoir was analyzed. The dolomite mineral samples were between 1 mm to 1 cm in diameter. The dolomite mineral was loaded into a stainless-steel ball mill. The ball mill was 15 cm long with an inner diameter of 2.5 cm. Stainless steel balls with a diameter of 2-3 mm were added to the ball mill. The ball mill was then air-tight capped and purged of air. The dolomite samples were crushed, and gases were released. The gases included methane, ethane, and CO₂. The released gases were analyzed for stable carbon isotopes, specifically the delta ¹³C (δ¹³C), reported in parts per thousand (permil). The definition of SPC in permil is:

$${δ}^{13} C = ( \frac{{( {}^{13} C / {}^{12} C )}_{sample}}{{( {}^{13} C / {}^{12} C )}_{standard}} - 1 ) \times 1000 \qquad Eq . 2$$

The isotope ratio was measured by isotope ratio mass spectrometry (IRMS). For example, the carbon isotopes in the methane, ethane, and CO₂ as gas inclusions in dolomite minerals were about −38 permil, −40 permil, and 8 permil, respectively, compared to a reference standard. A reference standard is an international stand such as NGS-1, NGS-2, and NGS-3, which contain natural gas compounds (methane, ethane, propane, and CO₂). This indicates that the dolomite was precipitated at a high temperature. This also indicates a high maturity of dry natural gas preserved in the dolomite. Oxygen isotopes in the dolomite were found to be about −19 permil, indicating that the dolomite precipitated at high temperature.

The term “about” as used in this disclosure can allow for a degree of variability in a value or range, for example, within 10%, within 5%, or within 1% of a stated value or of a stated limit of a range.

The term “substantially” as used in this disclosure refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “substantially simultaneously” as used in this disclosure refers to events that occur simultaneous, in quick succession, or within a few seconds of each other. For example, opening two valves substantially simultaneously refers to opening the two valves within a few seconds of each other.

The term “solvent” as used in this disclosure refers to a liquid that can dissolve a solid, another liquid, or a gas to form a solution. Non-limiting examples of solvents are silicones, organic compounds, water, alcohols, ionic liquids, and supercritical fluids.

The term “room temperature” as used in this disclosure refers to a temperature of about 15 degrees Celsius (° C.) to about 28° C.

The term “downhole” as used in this disclosure refers to under the surface of the earth, such as a location within or fluidly connected to a wellbore.

As used in this disclosure, the term “fluid” refers to liquids and gels, unless otherwise indicated.

As used in this disclosure, the term “subterranean material” or “subterranean zone” refers to any material under the surface of the earth, including under the surface of the bottom of the ocean. For example, a subterranean zone or material can be any section of a wellbore and any section of a subterranean petroleum- or water-producing formation or region in fluid contact with the wellbore. Placing a material in a subterranean zone can include contacting the material with any section of a wellbore or with any subterranean region in fluid contact the material. Subterranean materials can include any materials placed into the wellbore such as cement, drill shafts, liners, tubing, casing, or screens; placing a material in a subterranean zone can include contacting with such subterranean materials. In some examples, a subterranean zone or material can be any downhole region that can produce liquid or gaseous petroleum materials, water, or any downhole section in fluid contact with liquid or gaseous petroleum materials, or water. For example, a subterranean zone or material can be at least one of an area desired to be fractured, a fracture or an area surrounding a fracture, and a flow pathway or an area surrounding a flow pathway, in which a fracture or a flow pathway can be optionally fluidly connected to a subterranean petroleum- or water-producing region, directly or through one or more fractures or flow pathways.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

A number of implementations of the disclosure have been described. Nevertheless, it will be understood that various modifications may be made without departing from the spirit and scope of the disclosure.

### EMBODIMENTS

In some implementations, a system for analyzing gases trapped in inclusions in a solid sample includes an inert gas source, and a ball mill in fluid connection with the inert gas source. The ball mill includes a hollow cylinder and a plurality of crushing balls disposed inside the cylinder, and the ball mill is configured to be rotated around the longitudinal axis of the cylinder. The system includes a first valve disposed between the inert gas source and the ball mill, a cryogenic trap configured to cool the gases released from the inclusions, a second valve disposed between the ball mill and the cryogenic trap and in fluid connection with the ball mill, a third valve disposed between the cryogenic trap and an analysis instrument and in fluid connection with the second valve, and a fourth valve disposed between the third valve and the analysis instrument, wherein the fourth valve is a three way valve, wherein the three way valve can be opened to the atmosphere.

In an example implementation combinable with any other example implementation, the hollow cylinder is a stainless-steel cylinder.

In an example implementation combinable with any other example implementation, the crushing balls are stainless-steel balls.

In an example implementation combinable with any other example implementation, the system includes a stand for the ball mill.

In an example implementation combinable with any other example implementation, the system includes an electric motor configured to rotate the ball mill.

In an example implementation combinable with any other example implementation, the ball mill includes removable caps with an inner aperture, wherein the inner aperture is configured to be in fluid communication with the inert gas source or the second valve.

In an example implementation combinable with any other example implementation, the system includes a hydrogen sulfide trap. The hydrogen sulfide trap is disposed between the ball mill and the second valve. The hydrogen sulfide trap includes a container configured to hold a trapping liquid, and a cap with a gas inlet and a gas outlet. The gas inlet is in fluid communication with the ball mill and extends into the container and into the trapping liquid, and the gas outlet is in fluid communication with the second valve.

In an example implementation combinable with any other example implementation, the trapping liquid is a silver nitrate solution.

In an example implementation combinable with any other example implementation, the system includes a chromatography column disposed between the fourth valve and the analysis instrument.

In an example implementation combinable with any other example implementation, the analysis instrument is a mass spectrometry instrument.

In some implementations, a method for analyzing gases trapped in inclusions in a solid sample includes placing a solid sample in a ball mill, wherein the ball mill includes a hollow cylinder and a plurality of crushing balls disposed inside the cylinder, purging the ball mill of air, sealing the ball mill, rotating the ball mill to crush the solid sample and release the gases from the inclusions, directing the gases through a cryogenic trap, condensing the gases in the cryogenic trap forming condensed gases, removing the cryogenic trap to release the condensed gases forming released gases, directing the released gases through a gas chromatography column, separating the released gases based on the interaction between the released gases and a stationary phase of the column, and analyzing the released gases using a mass spectrometer.

In an example implementation combinable with any other example implementation, the method includes bubbling the gases through a trapping liquid disposed in a hydrogen sulfide trap before condensing the gases in the cryogenic trap.

In an example implementation combinable with any other example implementation, bubbling the gases through a trapping liquid includes bubbling the gases through a silver nitrate solution.

In an example implementation combinable with any other example implementation, purging the ball mill of air includes purging the ball mill with helium.

In an example implementation combinable with any other example implementation, rotating the ball mill to crush the solid sample and release the gases includes rotating the ball mill with an electric motor.

In an example implementation combinable with any other example implementation, condensing the gases in the cryogenic trap includes condensing the gases with liquid nitrogen.

In an example implementation combinable with any other example implementation, the method includes heating the released gases in an oven during separation.

In an example implementation combinable with any other example implementation, the method includes warming the condensed gases with a heat gun after removing the cryogenic trap.

In an example implementation combinable with any other example implementation, analyzing the released gases with a mass spectrometer includes analyzing the released gases with an isotope-ratio mass spectrometer.

In an example implementation combinable with any other example implementation, analyzing the released gases with an isotope-ratio mass spectrometer includes analyzing the stable isotopes in the released gases.

What is claimed is:

1. A system for analyzing gases trapped in inclusions in a solid sample, the system comprising:
an inert gas source;
a ball mill in fluid connection with the inert gas source, wherein the ball mill comprises
a hollow cylinder, and
a plurality of crushing balls disposed inside the cylinder, and wherein the ball mill is configured to be rotated around the longitudinal axis of the cylinder;
a first valve disposed between the inert gas source and the ball mill;
a cryogenic trap configured to cool the gases released from the inclusions;
a second valve disposed between the ball mill and the cryogenic trap and in fluid connection with the ball mill;
a third valve disposed between the cryogenic trap and an analysis instrument and in fluid connection with the second valve; and
a fourth valve disposed between the third valve and the analysis instrument, wherein the fourth valve is a three way valve, wherein the three way valve can be opened to the atmosphere.

2. The system of claim 1, wherein the hollow cylinder is a stainless-steel cylinder.

3. The system of claim 1, wherein the crushing balls are stainless-steel balls.

4. The system of claim 1, wherein the system includes a stand for the ball mill.

5. The system of claim 4, wherein the system includes an electric motor configured to rotate the ball mill.

6. The system of claim 1, wherein the ball mill includes removable caps with an inner aperture, wherein the inner aperture is configured to be in fluid communication with the inert gas source or the second valve.

7. The system of claim 1, further comprising a hydrogen sulfide trap, wherein the hydrogen sulfide trap is disposed between the ball mill and the second valve, and wherein the hydrogen sulfide trap comprises:
a container configured to hold a trapping liquid; and
a cap with a gas inlet and a gas outlet, wherein
the gas inlet is in fluid communication with the ball mill and extends into the container and into the trapping liquid, and
the gas outlet is in fluid communication with the second valve.

8. The system of claim 7, wherein the trapping liquid is a silver nitrate solution.

9. The system of claim 1, wherein the system further comprises a chromatography column disposed between the fourth valve and the analysis instrument.

10. The system of claim 1, wherein the analysis instrument is a mass spectrometry instrument.

11. A method for analyzing gases trapped in inclusions in a solid sample, comprising:
placing a solid sample in a ball mill, wherein the ball mill comprises a hollow cylinder and a plurality of crushing balls disposed inside the cylinder;
purging the ball mill of air;
sealing the ball mill;
rotating the ball mill to crush the solid sample and release the gases from the inclusions;
directing the gases through a cryogenic trap;
condensing the gases in the cryogenic trap forming condensed gases;
removing the cryogenic trap to release the condensed gases, forming released gases,
directing the released gases through a gas chromatography column;
separating the released gases based on the interaction between the released gases and a stationary phase of the column; and
analyzing the released gases using a mass spectrometer.

12. The method of claim 11, further comprising bubbling the gases through a trapping liquid disposed in a hydrogen sulfide trap before condensing the gases in the cryogenic trap.

13. The method of claim 12, wherein bubbling the gases through a trapping liquid comprises bubbling the gases through a silver nitrate solution.

14. The method of claim 11, wherein purging the ball mill of air comprises purging the ball mill with helium.

15. The method of claim 11, wherein rotating the ball mill to crush the solid sample and release the gases comprises rotating the ball mill with an electric motor.

16. The method of claim 11, wherein condensing the gases in the cryogenic trap comprises condensing the gases with liquid nitrogen.

17. The method of claim 11, further comprising heating the released gases in an oven during separation.

18. The method of claim 11, further comprising warming the condensed gases with a heat gun after removing the cryogenic trap.

19. The method of claim 11, wherein analyzing the released gases with a mass spectrometer comprises analyzing the released gases with an isotope-ratio mass spectrometer.

20. The method of claim 19, wherein analyzing the released gases with an isotope-ratio mass spectrometer comprises analyzing the stable isotopes in the released gases.
